(19) United States
(12) Patent Application Publication
(10) Pub. No.: US 2025/0358270 A1
(43) Pub. Date: Nov. 20, 2025

(54) AUTHENTICATION SYSTEM, AUTHENTICATION SERVER APPARATUS, AUTHENTICATION METHOD, AND PROGRAM

(71) Applicant: NEC Corporation, Minato- ku, Tokyo (JP)

(72) Inventors: Kengo MORI, Tokyo (JP); Haruna FUKUDA, Tokyo (JP); Toshiyuki ISSHIKI, Tokyo (JP)

(73) Assignee: NEC Corporation, Minato- ku, Tokyo (JP)

(21) Appl. No.: 18/870,721

(22) PCT Filed: Jun. 9, 2022
(86) PCT No.: PCT/JP2022/023232

§ 371 Date: Dec. 2, 2024

(51) Int. Cl. H04L 9/40

(52) U.S. Cl. CPC H04L 63/08

(57) ABSTRACT

The authentication system includes: an authentication client apparatus including a temporary conversion part that receives a feature to be authenticated and converts the feature into authentication query data using a temporary conversion parameter; and an authentication server apparatus including a registration feature data storage part and a matching part, the registration feature data storage part receiving a feature(s) to be registered in a system and storing registration feature data generated, the matching part executing matching on a basis of the registration feature data and the authentication query data.

### TECHNICAL FIELD

The present disclosure relates to an authentication system, an authentication server apparatus, an authentication method, and a program.

### BACKGROUND ART

In recent years, issues related to biometric information registered in biometric authentication has come to light. This is because biometric information is personal information, and leakage thereof causes problems regarding privacy. Since the biometric information cannot be destroyed or updated in an event of leakage, the leakage results in a loss of security for all authentication systems that use the same biometric.

Meanwhile, standardization organizations such as ISO (International Organization for Standardization) and ITU-T (International Telecommunication Union Telecommunication Standardization Sector) require to establish various standards for protecting biological information. For example, these organizations are requesting that even server administrators should not be able to obtain original biological information and that it should be possible to invalidate protected biological information.

Patent Literature (PTL) 1 discloses a system for detecting unauthorized authentication data at matching in authentication using biological information. In this system, registration data (a template) to be registered in the system is encrypted by homomorphic encryption at a time of registration, and authentication data thereof is also encrypted by the homomorphic encryption at a time of matching. The matching is executed between these encrypted data. In this way, it is possible to prevent unauthorized use of registration data or authentication data for authentication, etc. in other systems, by leakage through theft, etc., of the authentication data or the registration data.

### CITATION LIST

### Patent Literature

PTL 1: Japanese Patent Kokai Publication No. 2016-118984 A

### SUMMARY

### Technical Problem

The disclosure of PTL 1 is incorporated herein by reference thereto, and the following analysis has been made by the present inventors.

By encrypting registration data (templates) and authentication data as in PTL 1, it is possible to prevent leakage of biometric features in plaintext. However, spoofing is still possible using leaked registration data and authentication data on the system from which the registration data and authentication data have been leaked. In this respect, regarding the registration data, by introducing random numbers that cancel each other out between a template and a query in a matching calculation, it is possible to disable the matching calculations between the registration data (templates). This prevents using the registration data as the authentication data for spoofing.

However, regarding the authentication data (queries), if they are leaked, the method of the above countermeasures allows spoofing as they are accepted in authentication unless the registration data and the authentication data are encrypted again. Since authentication data is more likely to become a target of theft by phishing attacks, etc., it is desirable to take countermeasures in view of the above circumstances.

It is an object of the present disclosure to provide an authentication system, an authentication server apparatus, an authentication method, and a program that contribute to preventing spoofing (replay attacks) due to leakage of authentication query data in a biometric authentication system.

### Solution to Problem

According to a first aspect of the present invention or disclosure, there is provided an authentication system, including:
an authentication client apparatus that comprises a temporary conversion part that receives a feature to be authenticated and converts the feature into authentication query data using a temporary conversion parameter; and
an authentication server apparatus that comprises a registration feature data storage part and a matching part, the registration feature data storage part receiving a feature to be registered in a system and storing registration feature data generated, the matching part executing matching on a basis of the registration feature data and the authentication query data.

According to a second aspect of the present invention or disclosure, there is provided an authentication server apparatus, including:
a registration feature data storage part that stores registration feature data generated by receiving a feature to be registered in a system; and
a matching part that executes matching on a basis of authentication query data and the registration feature data, the authentication query data being obtained by receiving a feature to be authenticated and converting the feature using a temporary conversion parameter.

According to a third aspect of the present invention or disclosure, there is provided an authentication method, including:
a step of receiving a feature to be authenticated and converting the feature into authentication query data using a temporary conversion parameter;
a step of receiving a feature to be registered in a system and storing registration feature data generated; and
a step of executing matching on a basis of the registration feature data and the authentication query data.

According to a fourth aspect of the present invention or disclosure, there is provided a program, causing a computer to execute processing of:
receiving a feature to be registered in a system and storing registration feature data generated in a memory; and
executing matching on a basis of authentication query data and the registration feature data, the authentication query data being data converted a feature to be authenticated using a temporary conversion parameter.

### Advantageous Effects of Invention

According to the individual aspects of the present invention or disclosure, the present disclosure provides an authentication system, an authentication server apparatus, an authentication method, and a program that contribute to preventing spoofing (replay attacks) due to leakage of authentication query data in a biometric authentication system.

### BRIEF DESCRIPTION OF DRAWINGS

FIG. 1 is a schematic diagram illustrating an overview of a process of an authentication system according to an example embodiment.

FIG. 2 is a block diagram illustrating an example of a configuration of the authentication system according to the example embodiment.

FIG. 3 is a schematic diagram illustrating an overview of another process of the authentication system according to the example embodiment.

FIG. 4 is a schematic diagram illustrating an overview of a process of an authentication system according to a first example embodiment.

FIG. 5 is a schematic diagram illustrating an overview of another process of the authentication system according to the first example embodiment.

FIG. 6 is a block diagram illustrating an example of a configuration of the authentication system according to the first example embodiment.

FIG. 7 is a flowchart illustrating an operation of the authentication system according to the first example embodiment.

FIG. 8 is a schematic diagram illustrating a hardware configuration of the authentication system according to the first example embodiment.

FIG. 9 is a schematic diagram illustrating an overview of a process of an authentication system according to a second example embodiment.

FIG. 10 is a schematic diagram illustrating an overview of another process of the authentication system according to the second example embodiment.

FIG. 11 is a block diagram illustrating an example of a configuration of the authentication system according to the second example embodiment.

FIG. 12 is a diagram illustrating the flow of an operation of the authentication system according to the second example embodiment.

FIG. 13 is a diagram illustrating the flow of another operation of the authentication system according to the second example embodiment.

### EXAMPLE EMBODIMENTS

### [Overview of Process According to One Example Embodiment]

First, an overview of a process of an example embodiment will be described with reference to drawings. Note that reference signs in the drawings provided in the overview are for the sake of convenience for each element as an example to promote better understanding, and description of the overview is not to impose any limitations. An individual connection line between blocks in an individual drawing signifies both one-way and two-way directions. An individual arrow schematically illustrates a principal signal (data) flow and does not exclude bidirectionality. In addition, while not explicitly illustrated in the circuit diagrams, the block diagrams, the internal configuration diagrams, the connection diagrams, etc., in the disclosure of the present application, an input port and an output port exist at an input end and an output end of an individual connection line. The same holds true for the input-output interfaces.

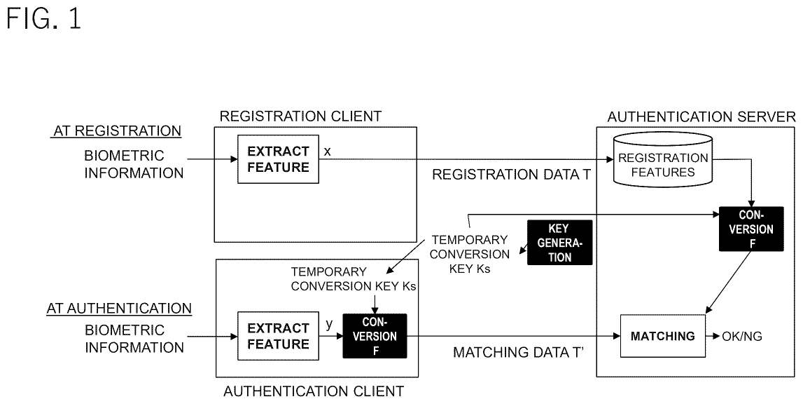

FIG. 1 is a schematic diagram illustrating an overview of a process of an authentication system according to an example embodiment. As illustrated in FIG. 1, a registration client receives biometric information and extracts a feature(s) x at registration. The registration client registers the feature(s) x as registration data T in a registration feature database.

At a time of authentication, an authentication client receives biometric information to be authenticated and extracts a feature y therefrom. Next, a temporary conversion key Ks is generated. Ks may be generated by an authentication server. Alternatively, Ks may be generated by another server, which is provided separately to generate a key. The authentication client executes a conversion F, which converts y using Ks. Matching data T′=Fks(y), which is obtained by the conversion F, is transmitted to the authentication server.

Here, it is assumed that the conversion F uses a scheme such as homomorphic encryption or the like, which can be matched (similarity calculation) while still encrypted, but which has a property that the matching fails if keys are different.

The authentication server executes matching between the registration data and the matching data. Since the matching data is obtained by converting feature using Ks, all registration features to be matched are also converted by conversion Fks and then updated from x to Fks(x) for matching.

As described above, a temporary conversion key is generated, and matching data is obtained by converting (encrypting) feature therewith at a time of authentication, so that, each time a key is generated, matching data obtained by converting feature using a different key is transmitted to the authentication server. In this way, even if matching data is, for example, leaked through theft, etc., another conversion key is generated, and matching data is obtained by converting feature therewith.

Therefore, even if the leaked matching data is transmitted to the authentication server again, because the conversion keys are different, the matching data will not be matched, i.e., the authentication fails.

### [Configuration of One Example Embodiment]

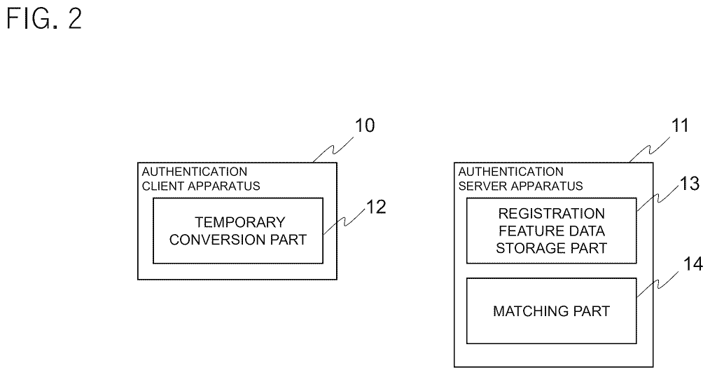

Next, a configuration of the authentication system according to the example embodiment will be described with reference to drawings. FIG. 2 is a block diagram illustrating an example of a configuration of the authentication system according to the example embodiment. As illustrated in FIG. 1, the authentication system according to the example embodiment is provided with an authentication client apparatus 10 and an authentication server apparatus 11. The authentication client apparatus 10 is provided with a temporary conversion part 12. The authentication server apparatus 11 is provided with a registration feature data storage part 13 and a matching part 14.

Although not illustrated in FIG. 2, the authentication server apparatus 11 may be provided with a temporary conversion parameter generation part that generates a temporary conversion key. An apparatus different from the authentication client apparatus 10 and the authentication server apparatus 11 may be provided with the temporary conversion parameter generation part.

The temporary conversion part 12 receives a feature to be authenticated and converts the feature into authentication query data using a temporary conversion parameter, in the authentication client apparatus 10.

This “authentication query data” is matching source data to be matched with a registration feature(s). In the present example embodiment, the “authentication query data” refers to the data transmitted from the authentication client apparatus 10 to the authentication server apparatus 11 for being matched with a registration feature(s), which is stored in the registration feature data storage part 13, in the matching part in the authentication server apparatus 11.

The registration feature data storage part 13 receives a feature(s) to be registered in the system and stores generated registration feature data, in the authentication server apparatus 11.

The matching part 14 executes matching on a basis of the registration feature data and the authentication query data. In the authentication system according to the example embodiment, the matching part 14 executes matching between the authentication query data and data converted on a basis of the registration feature data.

### [Overview of Another Process According to One Example Embodiment]

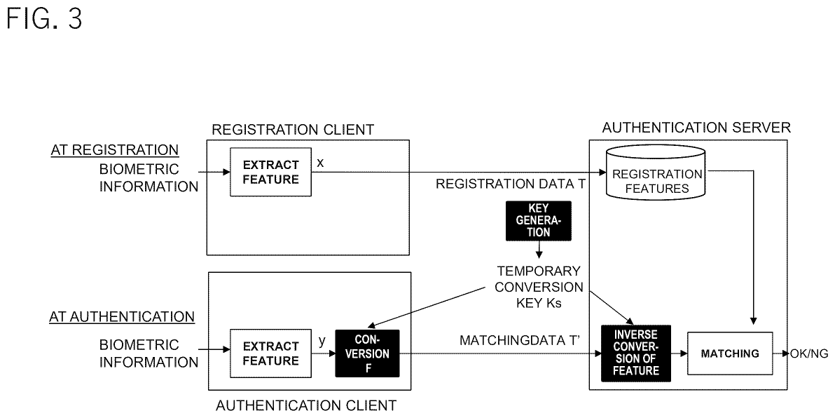

FIG. 3 is a schematic diagram illustrating an overview of another process of the authentication system according to the example embodiment. As illustrated in FIG. 3, the temporary conversion key Ks is generated, and the feature data y to be authenticated is converted by conversion Fks in the authentication client. The matching data T′=Fks(y), which is the result of the conversion, is transmitted to the authentication server. In the authentication server, y is calculated from Fks(y) by inverse conversion using the temporary conversion key Ks, before matching, and then matched with the registration feature(s) x.

Here, the “inverse conversion” refers to obtaining y from Fks(y) using the conversion key Ks, for example, if feature data y is converted by Fks to Fks(y).

That is, the matching part 14 in the authentication server apparatus 11 executes an inverse conversion on a basis of the authentication query data and executes matching between the resultant data y and the registration feature data x. In this case, it is necessary to assume that Fks uses a conversion scheme that allows inverse conversion.

In the process described in the above overview of another process, for the matching, the feature conversion is executed only once on the matching data T′ in the authentication server apparatus 11. Thus, the processing can be executed faster than that in the mode as described in the overview of the example embodiment in which all the registration features to be matched are converted.

In the authentication system according to the example embodiment, as described above, even if biometric information to be authenticated is leaked, for example, in the authentication process, it is possible to prevent from being passed the authentication in the system, from which the biometric information has been leaked, through spoofing, by generating a new temporary conversion key.

Hereinafter, specific example embodiments will be described in more detail with reference to drawings. In the individual example embodiments, the same components will be denoted by the same reference signs or numbers, and description thereof will be omitted.

### First Example Embodiment

In the authentication system according to the above example embodiment, on an occasion that a feature(s) is registered in the system, registration feature data is transmitted to the authentication server in plaintext. Therefore, if the registration feature data (a template(s)) is leaked, there is a possibility that the feature(s) will be used to other biometric authentication systems.

In an authentication system according to the present example embodiment, a registration client can convert (encrypt) a registration feature(s) to be registered using a conversion key K at a time of registration. In this way, at the time of registration, the registration feature(s) to be registered is not transmitted from the registration client to an authentication server in plaintext to be stored in the registration feature database, but is stored therein in a converted (encrypted) form.

### [Overview of Process According to First Example Embodiment]

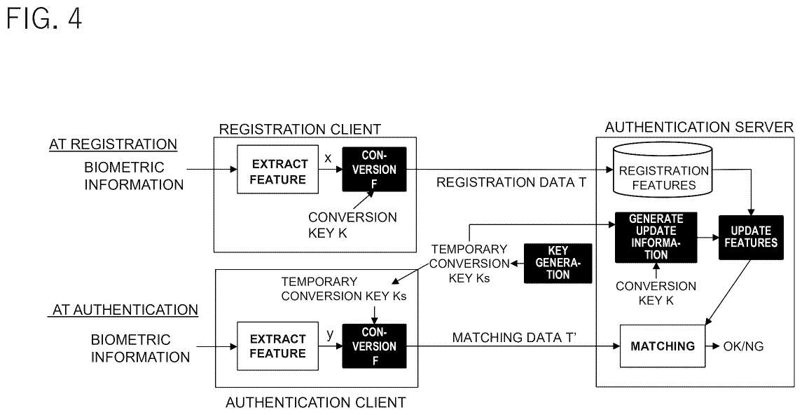

FIG. 4 is a schematic diagram illustrating a process of the authentication system according to the first example embodiment. As illustrated in FIG. 4, a conversion key K is generated in advance, a feature(s) x acquired at the time of registration is converted into Fk(x) using K, and then registered in a registration feature database in the authentication server apparatus. At a time of authentication, each time a temporary conversion key Ks is generated, the authentication server generates update information Δ(K, Ks) from the conversion key K to the temporary conversion key Ks. For this generation process, for example, a technique for generating a re-encryption key for proxy re-encryption may be adopted. At a time of matching, the authentication server uses the registration feature(s) as input, generates the updated registration features using the generated update information, and executes matching. That is, each time Ks is generated, the authentication server updates all the registration features from Fk(x) to Fks(x) using the generated update information, and then executes matching. An authentication client transmits matching data T′=Fks(y), which is converted and generated using the temporary conversion key Ks, to the authentication server for matching.

### [Overview of Another Process According to First Example Embodiment]

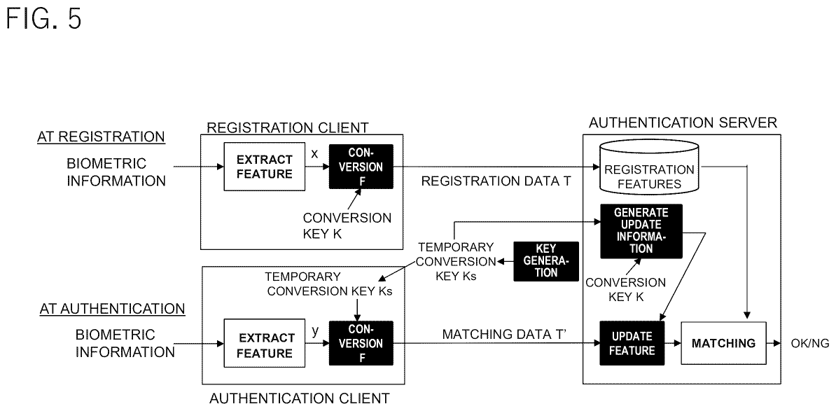

FIG. 5 is a schematic diagram illustrating an overview of another process of the authentication system according to the first example embodiment. In another mode of the authentication system according to the present example embodiment, the authentication server can execute matching process by updating the feature of the matching data T′=Fks(y) transmitted from the authentication client to be Fk(y) using the update information Δ(Ks, K) from the temporary conversion key Ks to the conversion key K.

### [Configuration According to First Example Embodiment]

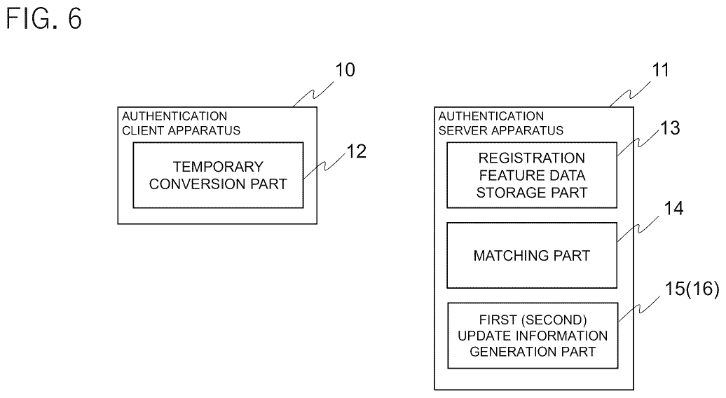

Next, a configuration of the authentication system according to the first example embodiment will be described with reference to drawings. FIG. 6 is a block diagram illustrating an example of a configuration of the authentication system according to the present example embodiment. As illustrated in FIG. 6, the authentication system according to the present example embodiment is provided with an authentication client apparatus 10 and an authentication server apparatus 11. The authentication client apparatus 10 is provided with a temporary conversion part 12. The authentication server apparatus 11 is provided with a registration feature data storage part 13, a matching part 14, and a first (second) update information generation part 15 (16).

The temporary conversion part 12 receives a feature to be authenticated and converts the feature into authentication query data using a temporary conversion parameter, in the authentication client apparatus 10. The “feature to be authenticated” is vector data extracted from an image acquired by a device such as a camera, etc., by applying predetermined image processing, etc., and converted into numerical values. The “temporary conversion parameter” is a parameter (encryption key) used to execute a predetermined conversion F (encryption) on the feature to be authenticated. In principle, it is desirable for the temporary conversion parameter to be newly generated each time an authentication request is received from an authentication client. However, it is not necessary to generate a temporary conversion parameter in response to every authentication request. A temporary conversion parameter may be generated at arbitrary timing, for example, at an occasion that an external attack is suspected.

The “temporary conversion parameter” may be generated by an apparatus different from the authentication client apparatus 10 and the authentication server apparatus 11. For example, a hardware device used to generate a one-time password may generate a password or a random number that serves as a seed, and the password or the random number may be transmitted, for example, to the authentication client apparatus 10, which then may generate a temporary conversion parameter.

The registration feature data storage part 13 receives a feature(s) to be registered in the system and stores generated registration feature data. The “feature(s) to be registered in the system” refers to information that is used as a template(s) used for so-called authentication. In the authentication system according to the present example embodiment, as illustrated in FIGS. 4 and 5, a feature(s) to be registered in the system is converted into registration feature data, using a key K (predetermined conversion parameter), which is common between the authentication server and the registration client. This converted registration feature data is transmitted to the authentication server and stored in the registration feature database. The common key K is generated at least once at a time when the authentication system operates. In a case that K is updated, all the registration features stored in the authentication server need to be overwritten and updated.

In FIGS. 4 and 5, the registration client is configured to execute the conversion process and transmits the converted registration feature data to the authentication server. Although this conversion process may be configured to be executed on the authentication server side, it is desirable that the conversion be executed on the registration client side because the feature(s) will flow in a plaintext over the communication paths.

The first update information generation part 15 generates first update information for updating data converted using the predetermined conversion parameter to data converted using the temporary conversion parameter. At a time of authentication, each time a temporary conversion key Ks including temporary conversion parameter is generated, the first update information generation part 15 generates update information Δ(K, Ks) to update from the temporary conversion key Ks including the temporary conversion parameter to the conversion key K including the predetermined conversion parameter.

In contrast to the first update information generation part 15, the second update information generation part 16 generates second update information for updating data converted using the temporary conversion parameter to data converted using the predetermined conversion parameter.

At a time of authentication, each time a temporary conversion key Ks including a temporary conversion parameter is generated, the second update information generation part 16 generates update information Δ(Ks, K) to update from the temporary conversion key Ks including the temporary conversion parameter to the conversion key K including the predetermined conversion parameter.

The matching part 14 executes matching on a basis of the registration feature data and the authentication query data. In a case of a configuration having the first update information generation part 15 (FIG. 4), Fk(x) is updated to Fks(x) using the update information Δ(K, Ks) for all registration feature data at the time of matching, and then is matched with the authentication query, T′=Fks(y).

In a case of a configuration having the second update information generation part 16 (FIG. 5), T′=Fks(y) is updated to Fk(y) using the update information Δ(Ks, K), and then is matched with Fk(x) of the registration feature data.

### [System Operation]

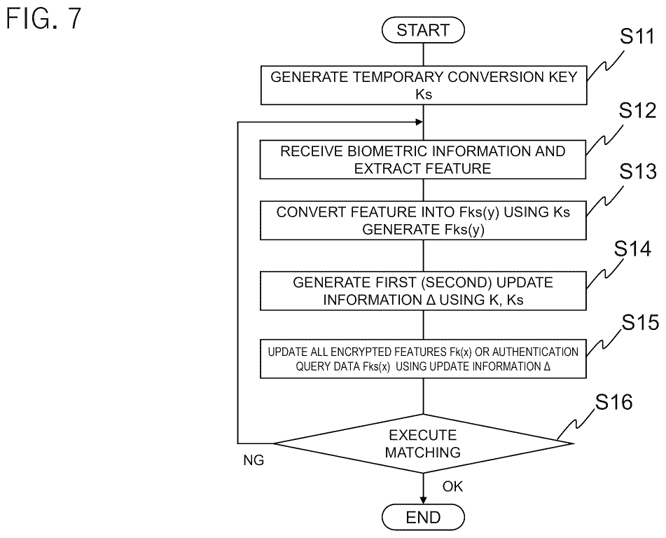

FIG. 7 is a flowchart illustrating an operation of the authentication system according to the first example embodiment. FIG. 7 illustrates a sequence of operations until authentication succeeds at the time of system authentication. First, a temporary conversion key Ks is generated (step S11). Next, the system receives biometric information of biological body to be authenticated and extracts a feature therefrom (step S12). Next, the extracted feature is converted using the temporary transformation key Ks to be Fks(y) (step S13). Next, the first update information Δ(K, Ks) or the second update information Δ(Ks, K) is generated (step S14). Next, all the features Fk(x) (or the authentication query data Fks(x)) are updated using the first (second) update information Δ (step S15).

Next, matching is executed (step S16). Concretely, a similarity is calculated by calculating a distance between the updated converted registration feature data Fks(x) and the authentication query data Fks(y). If the similarity is within the predetermined acceptance criteria, the data is accepted (step S16: OK), and the authentication using the temporary conversion key Ks is completed. If the similarity is outside the acceptance criteria, it is considered unacceptable (step S16: NG) and the process returns to the process of receiving biometric information and extracting a feature (step S12) again.

### [Hardware Configuration]

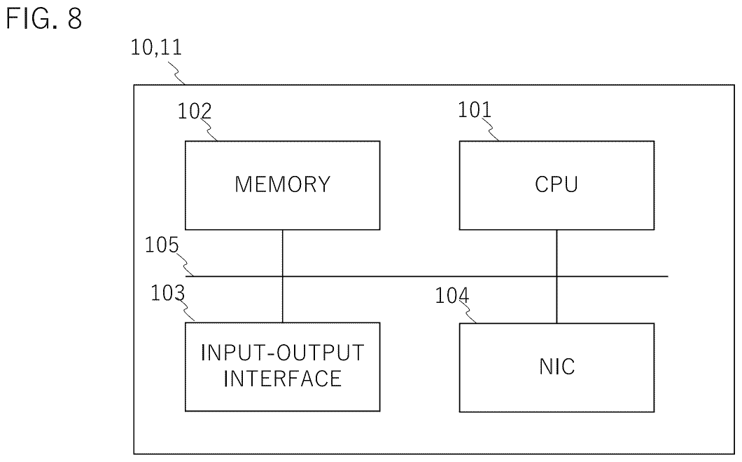

The authentication system according to the present example embodiment can be executed by an information processing apparatus (a computer). The authentication system is provided with an authentication client apparatus 10 and an authentication server apparatus 11, each of which is configured with the authentication system and has a configuration illustrated as an example in FIG. 8. That is, each of the authentication client apparatus 10 and the authentication server apparatus 11 is provided with, for example, a CPU (Central Processing Unit) 101, a memory 102, an input-output interface 103, and a NIC (Network Interface Card) 104, which serves as communication means. These components are connected to each other via an internal bus 105.

The configuration illustrated in FIG. 8 is not intended to limit the hardware configuration of the authentication system. The authentication client apparatus 10 and the authentication server apparatus 11 may include other hardware not illustrated or may be configured without their respective input-output interfaces 103 as appropriate. For example, the number of CPUs included in each of these apparatuses is not limited to the example illustrated in FIG. 8. For example, a plurality of CPUs may be included in each of the authentication client apparatus 10 and the authentication server apparatus 11.

The memory 102 in FIG. 8 is a RAM (Random Access Memory), a ROM (Read Only Memory), or an auxiliary storage device (a hard disk or the like).

The input-output interface 103 in FIG. 8 is means serving as an interface for a display device or an input device not illustrated. The display device is a liquid crystal display or the like, and the input device is a camera or a sensor that receives biometric information and a device such as a keyboard or a mouse that receives user operations.

Functions of the authentication client apparatus 10 and the authentication server apparatus 11 are realized by a group of programs (processing modules) such as a temporary conversion program, a first (second) update information generation program, and a matching program and a group of data such as parameters used by the individual programs. These programs and data are each stored in a corresponding one of the memories 102. The processing modules are each realized, for example, when a corresponding one of the CPUs 101 executes a program stored in a corresponding one of the memories 102. The individual program can be updated by downloading a program via a network or by using a storage medium storing a program. In addition, the above-described processing modules may be realized by semiconductor chips. That is, there may be some hardware and/or software means to execute the functions executed by the above-described processing modules.

### [Hardware Operation]

At a time when the authentication system starts its operation, the authentication client apparatus 10 invokes the temporary conversion program from its memory 102, and this program becomes executable by the CPU 101. This temporary conversion program applies conversion F (encryption) to a feature, which has been extracted from biometric information y acquired by the input-output interface 103, using a conversion key generated from a temporary conversion parameter Ks generated and acquired. The authentication client apparatus 10 transmits a feature Fks(y), which is converted, to the authentication server apparatus 11 via its NIC 104, etc.

In the authentication server apparatus 11, the memory 102 stores the converted registration feature(s) Fk(x) converted using a predetermined conversion parameter K. The authentication server apparatus 11 invokes the first (second) update information generation program from its memory 102, and this program becomes executable by the CPU 101. The program is capable of converting data by updating data using keys based on two different conversion parameters. The first update information generation program generates the update information Δ(K, Ks). The second update information generation program generates the update information Δ(Ks, K).

Next, the authentication server apparatus 11 invokes the matching program from its memory 102, and this program becomes executable by the CPU 101. This program updates the converted feature(s) using the update information Δ and executes the matching process. Concretely, the program uses the update information Δ(K, Ks) to update all of the converted registration features Fk(x) stored in the memory 102 to the features Fks(x) using the temporary conversion parameter Ks, and matches these features Fks(x) against Fks(y), which has been converted using the same parameter Ks and transmitted from the authentication client apparatus. In the matching, the program calculates the distance between Fks(x) and Fks(y) to obtain the similarity therebetween. If the distance is a predetermined value or less, Fks(y) will be accepted. If the distance is greater than the predetermined value, Fks(y) will be NG.

Similarly, in a case where using the update information Δ(Ks, K), the matching program converts the converted feature Fks(y) transmitted from the authentication client apparatus 10 into Fk(y), using thereof, and executes matching with the converted registration features Fk(x) stored in the memory 102. Because the matching process has already been described above in detail, the description thereof will be omitted.

### Advantageous Effects

Thus, in the authentication system according to the present example embodiment allows the registration features to be kept secret by conversion, but does not require the registration feature database to be rewritten for matching even if a new temporary conversion key is generated, and enables matching by updating the registration features (after conversion) using updated information at the time of matching. In addition, when generating temporary conversion keys, it is not necessary to distribute conversion keys to all authentication clients, but only to authentication clients and authentication servers that require authentication, which has an effect of reducing key delivery costs and improving security.

Furthermore, as described in [Overview of Another Process According to First Example Embodiment], by updating the key that is converting the authentication query data using the update information at the time of matching (temporary conversion parameter->predetermined conversion parameter), the data can be updated only once per authentication. This has the advantageous effect that the process can be executed faster than updating all of the converted registration features using updated information, as described in [Configuration According to First Example Embodiment].

### [Overview of Process According to Second Example Embodiment]

As described in the above example embodiment, by using the update information Δ for the conversion key (conversion parameter), the matching process can be on a basis of the authentication query data obtained by the conversion using the temporary conversion key Ks and the (converted) registration feature data. However, as can be seen from FIGS. 3 and 4, the predetermined conversion key (conversion parameter) K and the registration feature data converted using K are stored in the same authentication server apparatus as each other. In the unlikely event that the authentication server apparatus is attacked, there is still a concern that the registration feature data could be decrypted using K and that the features will be leaked in plaintext.

The present example embodiment provides an authentication system that has an effect of the above example embodiment, but with a configuration that does not use K, which is a predetermined conversion parameter, in the authentication server

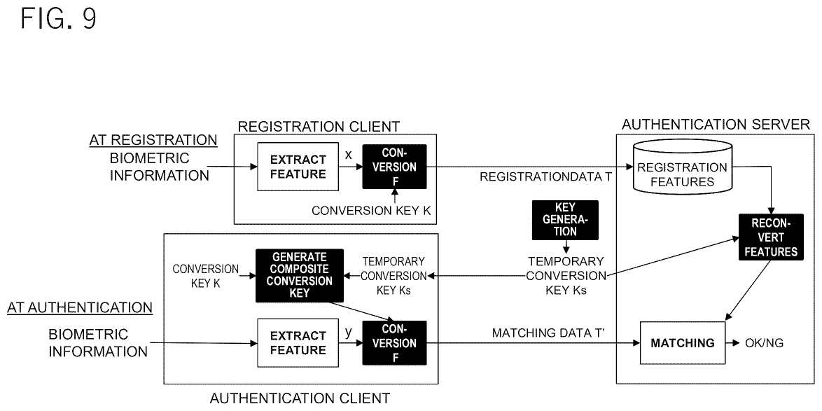

FIG. 9 is a schematic diagram illustrating an overview of a process of an authentication system according to a second example embodiment. As illustrated in FIG. 9, at a time of registration, a predetermined conversion key K is delivered to a registration client, and a feature(s) x to be registered in the system is converted and stored in a registration feature database in an authentication server as converted registration feature data Fk(x).

At a time of authentication, after a temporary conversion key Ks is generated and transmitted to an authentication client apparatus, the authentication client apparatus generates a composite conversion key Ks·K using the conversion key K and the temporary conversion key Ks delivered to the authentication client apparatus by the time of authentication. At a time of authentication, the authentication client apparatus converts a feature y using the composite conversion key Ks·K, and transmits T′=F{ks·k}(y)=Fks(Fk(y)) as authentication query (matching) data to the authentication server. The authentication server obtains the temporary conversion key Ks, and reconverts the converted registration feature data Fk(x) using Ks to update into Fks(Fk(x)), and executes matching thereof with authentication query T′=Fks(Fk(y)).

### [Overview of Another Process According to Second Example Embodiment]

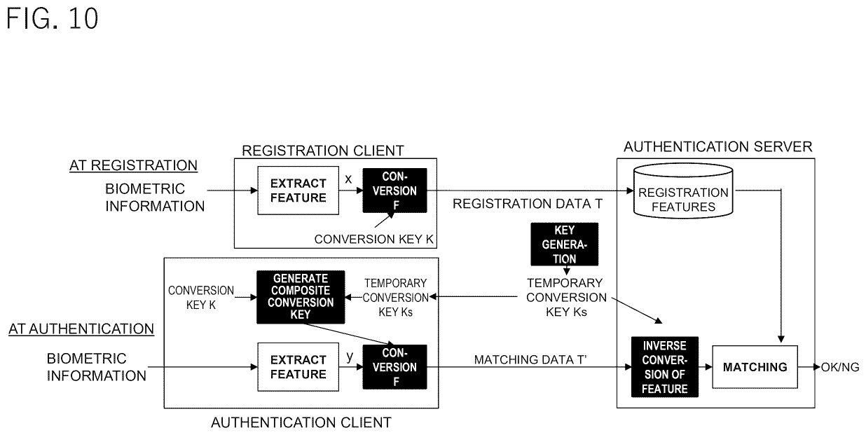

FIG. 10 is a schematic diagram illustrating an overview of another process of the authentication system according to the second example embodiment. As illustrated in this figure, in the process in FIG. 9, the converted registration feature data is reconverted and is matched with the authentication query (matching) data compositely converted. However, in this overview of another process, based on a property that the feature T′=F{ks·k}(y)=Fks(Fk(y)) converted using the composite conversion key Ks·K is reversely convertible, the converted authentication query (matching) data is converted into Fk(y), and then is matched with the registration features Fk(x).

### [Configuration According to Second Example Embodiment]

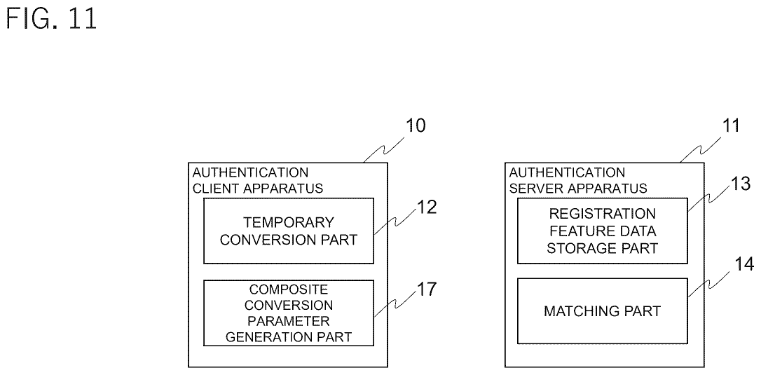

Next, a configuration of the authentication system according to example embodiment 2 will be described with reference to drawings. FIG. 11 is a block diagram illustrating an example of a configuration of the authentication system according to the present example embodiment. As illustrated in FIG. 11, the authentication system according to the present example embodiment is provided with an authentication client apparatus 10 and an authentication server apparatus 11. The authentication client apparatus 10 is provided with a temporary conversion part 12 and a composite conversion parameter generation part 17. The authentication server apparatus 11 is provided with a registration feature data storage part 13 and a matching part 14. A further feature of the present example embodiment is that the authentication client apparatus 10 has a composite conversion parameter generation part 17.

The composite conversion parameter generation part 17 generates a composite conversion parameter for executing a conversion in which the conversion using the predetermined parameter (K) and the conversion using the above-descried temporary conversion parameter (Ks) are composited, in the authentication client apparatus 10. The generated composite conversion parameter is transmitted to the temporary conversion part 12.

In the present example embodiment, the temporary conversion part 12 receives the composite conversion parameter from the composite conversion parameter generation part 17, and converts a feature to be authenticated into composite converted authentication query data.

In the present example embodiment, the matching part 14 reconverts the converted registration feature data using the temporary conversion parameter, and executes matching thereof with the composite converted authentication query data, in the authentication server apparatus 11.

### [Another Configuration According to Second Example Embodiment]

In the present example embodiment, in another configuration according to the second example embodiment corresponding to [Overview of Another Process According to Second Example Embodiment], based on the configuration according to the second example embodiment described above, the matching part 14 inversely converts the composite converted authentication query data using the temporary conversion parameter to execute matching thereof with the converted registration feature data.

### [System Operation]

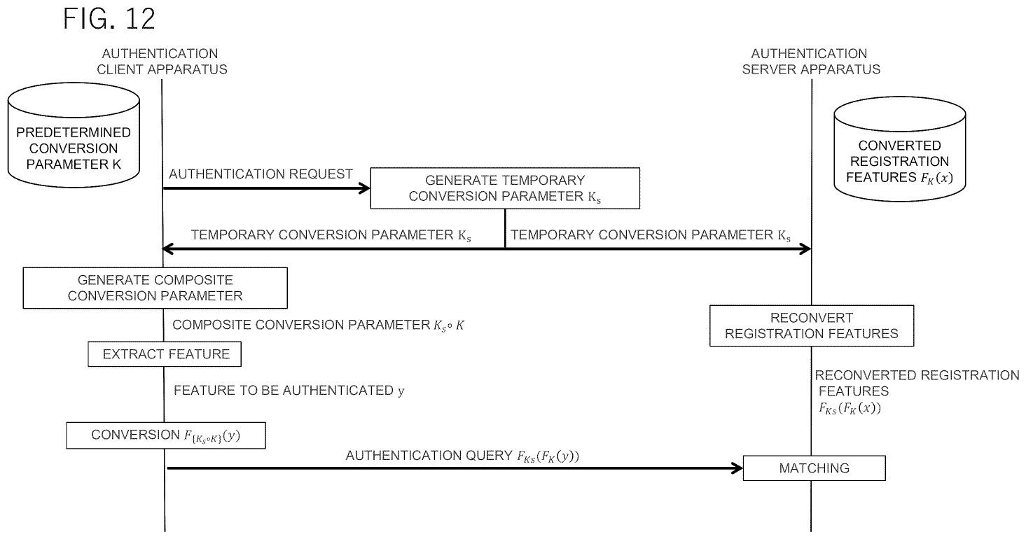

FIG. 12 is a diagram illustrating the flow of an operation of the authentication system according to the second example embodiment. In particular, FIG. 12 is a diagram illustrating the flow of the authentication in the authentication system according to the present example embodiment. As illustrated in FIG. 12, first, in the registration phase, a predetermined conversion parameter K has already been delivered to the authentication client apparatus. In the authentication server apparatus, a converted registration feature Fk(x), which is a registration feature converted using the predetermined conversion parameter K, is already stored.

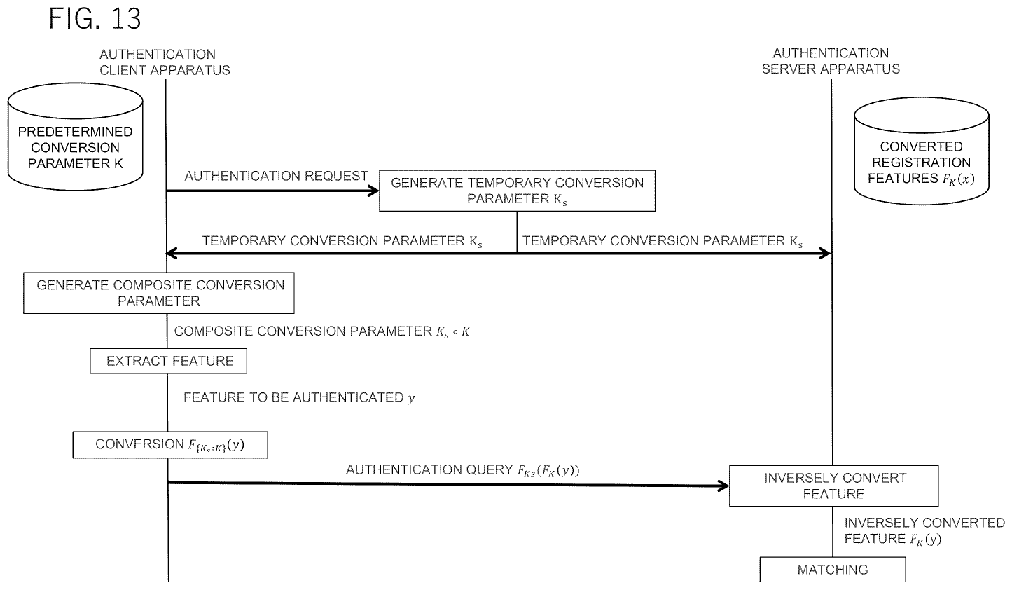

Upon receiving an authentication request from the authentication client apparatus, a temporary conversion parameter Ks is generated and delivered to the authentication client apparatus and the authentication server apparatus. This Ks may be generated by the authentication server apparatus or by an independent temporary conversion parameter generation apparatus. Next, in the authentication client apparatus, a composite conversion parameter Ks·K (a composite conversion operator · is denoted by a white circle in FIGS. 12 and 13 and the same applies hereinafter) is generated. Meanwhile, in the authentication server apparatus, the converted registration features Fk(x) is reconverted using the temporary conversion parameter Ks and the reconverted registration feature(s) Fks(Fk(x)) is calculated.

The authentication client apparatus accepts biometric information and extracts a feature y for authentication. Next, the authentication client apparatus executes a conversion process using the composite conversion parameter Ks·K, to calculate F{ks·k}(y)=Fks(Fk(y)). The authentication client apparatus transmits F{ks·k}(y)=Fks(Fk(y)) to the authentication server apparatus as an authentication query (matching data), and the authentication server apparatus executes matching.

### [Another System Operation]

FIG. 13 is a diagram illustrating the flow of another operation of the authentication system according to the second example embodiment. The difference from the above operation is that after the authentication query (matching data) is transmitted from the authentication client apparatus, the authentication server apparatus executes a process such as an inverse conversion of the feature of the authentication query using the temporary conversion parameter Ks. After the inverse conversion (Fks(Fk(y))->Fk(y)), the authentication server apparatus obtains the feature Fk(y) and executes matching process between the feature Fk(y) and the converted registration features Fk(x) stored in the authentication server apparatus.

### Advantageous Effects

In the authentication system according to the present example embodiment, the authentication client apparatus temporarily converts a feature to be authenticated using a composite conversion parameter, which composites the temporary conversion parameter Ks and the predetermined conversion parameter K. This eliminates the need for processing using the predetermined conversion parameter K in the authentication server. Both the conversion parameter K and the converted registration feature data Fk(x) are not stored in a memory. This reduces a risk of an attack on the authentication server apparatus in which both K and Fk(x) are stolen to decrypt Fk(x) and leak a feature value x in plaintext form.

### Third Example Embodiment

In the authentication systems according to the first and second example embodiments, if an authentication query and a temporary conversion key corresponding thereto are simultaneously leaked, spoofing becomes possible using both pieces of information. For example, if the authentication query T′=Fks(y) and the temporary conversion key Ks in an authentication process are leaked, for a temporary conversion key Kt transmitted from the authentication server apparatus in another authentication process, the update information Δ(Ks, Kt) can be calculated from Ks and Kt. By using Δ(K, Ks, t) to update T′=Fks(y) to Fkt(y) and transmitting thereof as an authentication query, the matching process can be OK. If a conversion technique in which the inverse conversion is easily calculated is used, the feature y itself can also be reconstructed from the authentication query and the temporary conversion key.

The authentication system according to the present example embodiment is configured based on the authentication systems according to the first and second example embodiments. By using secret information shared by the authentication client apparatus and the authentication server apparatus in advance, the authentication system can prevent spoofing even if the temporary conversion key Ks and the authentication query are simultaneously leaked.

In the above configuration described in [Overview of Process According to First Example Embodiment], the authentication client apparatus generates another temporary conversion key Ku from the temporary conversion key Ks and the shared secret information, and transmits T′=Fku(y) as an authentication query. The authentication server apparatus also generates Ku, calculates Δ(K, Ku) as update information, and updates the registration feature(s) Fk(x) to Fku(x) converted using Ku for matching. Since Ks and T′=Fku(y) are based on different conversion keys, even if Ks and T′=Fku(y) are simultaneously leaked, they cannot be used for spoofing.

In the above configuration described in [Overview of Another Process According to First Example Embodiment], the update information is to be Δ(Ku, K), and the matching query Fku(y) is updated to Fk(y) using Δ(Ku, K) for matching.

In the above configuration described in [Overview of Process According to Second Example Embodiment], the authentication client apparatus generates another temporary conversion key Ku from the temporary conversion key Ks and the shared secret information, and transmits T′=Fku(Fk(y)) as an authentication query. The authentication server apparatus also generates Ku, and updates the registration feature(s) Fk(x) to Fku(Fk(x)) reconverted using Ku for matching. Since Ks and T′=Fku(Fk(y)) are based on different conversion keys, even if Ks and T′=Fku(Fk(y)) are simultaneously leaked, Ks and T′=Fku(Fk(y)) cannot be used for spoofing.

In the above configuration described in [Overview of Another Process According to Second Example Embodiment], the authentication server apparatus inversely converts the matching query Fku(Fk(y)) to Fk(y) using Ku and matches it.

In the above modes, the shared secret information can be, for example, a cancellable conversion key K used at the time of registration, which is not a temporary conversion key, or a “master parameter” that are shared in advance by the authentication client and the authentication server. The method of generating the temporary conversion key Ku may be such that the shared secret information is a predetermined conversion key K, and Ku is that which satisfies Fku(*)=Fk(Fks(*)), that the shared secret information is a master parameter param, and Ku is an output when (Ks∥param) is given as an input random number seed in the key generation process, or the like.

### Fourth Example Embodiment

In the authentication system according to the first example embodiment, the predetermined conversion key K always needs to be stored in the authentication server side, and this raises a security concern. In the authentication system according to the present example embodiment, only part of the predetermined conversion key K (for example, only the second half of the key) is stored in the authentication server. In this way, it is possible to prevent spoofing attacks using a leaked authentication query.

In a configuration of the authentication system according to the fourth example embodiment, the authentication server apparatus is provided with a challenge generation part (not illustrated) and a verification part (not illustrated), in which the challenge generation part generates and transmits thereof to an authentication client apparatus; and the verification part receives a response and verifies thereof using a temporary conversion parameter. In the authentication client apparatus, the temporary conversion part further converts the challenge using the temporary conversion parameter and transmits thereof as a response to the verification part of the authentication server apparatus. The verification part of the authentication server apparatus executes verification using a part of the predetermined conversion parameter.

The operation of the authentication system according to the present example embodiment is as follows. First, the authentication server generates a sequence of random numbers to be used at a time when an authentication query is temporarily converted, and transmits thereof to the authentication client as a challenge. Meanwhile, the authentication server apparatus uses part of the predetermined conversion key K (for example, only the second half thereof) to convert the sequence of random numbers transmitted, and stores thereof as check data. Upon receiving an authentication query, the authentication server apparatus checks whether the values in the check data portion match, in addition to the normal matching process. If there is a mismatch in even one place, the authentication is rejected.

In the authentication system according to the present example embodiment, it is only necessary for the authentication server apparatus to store only part of the predetermined conversion key K, and a security concern such as data leakage due to attacks can be reduced.

Part or all of the above-described example embodiments can also be described as the following notes. However, each of the following notes is merely an example of the present disclosure, and therefore, the present disclosure is not limited to these notes.

### [Note 1]

See the authentication system according to the above first aspect.

### [Note 2]

In the authentication system according to note 1, preferably, the matching part in the authentication server apparatus converts the registration feature data using the temporary conversion parameter and executes matching.

### [Note 3]

In the authentication system according to note 1, preferably, the matching part in the authentication server apparatus inversely converts the authentication query data using the temporary conversion parameter and executes matching.

### [Note 4]

In the authentication system according to note 1, preferably,
at a time of registering the feature to be registered in the system, the registration feature data storage part in the authentication server apparatus stores a converted registration feature data that is registered by converting the feature using a predetermined conversion parameter; and
the matching part in the authentication server executes matching between the converted registration feature data and the authentication query data.

### [Note 5]

In the authentication system according to note 4, preferably,
the authentication server apparatus further includes a first update information generation part that generates first update information for updating data converted using the predetermined conversion parameter to data converted using the temporary conversion parameter; and
the matching part updates the converted registration feature data using the first update information and executes matching with the authentication query data.

### [Note 6]

In the authentication system according to note 4, preferably,
the authentication server apparatus further include a second update information generation part that generates second update information for updating data converted using the temporary conversion parameter to data converted using the predetermined conversion parameter; and
the matching part updates the authentication query data using the second update information and executes matching with the converted registration feature data.

### [Note 7]

In the authentication system according to note 4, preferably,
the authentication client apparatus includes a composite conversion parameter generation part that generates a composite conversion parameter for executing a conversion in which a conversion using the predetermined conversion parameter and a conversion using the temporary conversion parameter are composited;
the temporary conversion part converts the feature to be authenticated into composite converted authentication query data using the composite conversion parameter; and
in the authentication server apparatus, the matching part reconverts the converted registration feature data using the temporary conversion parameter and executes matching with the composite converted authentication query data.

### [Note 8]

In the authentication system according to note 4, preferably,
the authentication client apparatus includes a composite conversion parameter generation part that generates a composite conversion parameter for executing a conversion in which a conversion using the predetermined conversion parameter and a conversion using the temporary conversion parameter are composited;
the temporary conversion part converts the feature to be authenticated into composite converted authentication query data using the composite conversion parameter; and
in the authentication server apparatus, the matching part inversely converts the composite converted authentication query data using the temporary conversion parameter and executes matching with the converted registration feature data.

### [Note 9]

In the authentication system according to any one of notes 5 to 8, preferably,
the authentication client apparatus includes a first secret information temporary conversion parameter generation part that generates a secret information temporary conversion parameter using secret information shared with the authentication server apparatus and the temporary conversion parameter;
the temporary conversion part converts the feature to be authenticated into secret information temporarily converted authentication query data using the secret information temporary conversion parameter, instead of using the temporary conversion parameter; and
the authentication server apparatus includes a second secret information temporary conversion parameter generation part that generates the secret information temporary conversion parameter using secret information shared with the authentication client apparatus and the temporary conversion parameter.

### [Note 10]

In the authentication system according to note 9, preferably,
in the authentication server apparatus, the matching part converts the converted registration feature data using the secret information temporary conversion parameter and executes matching with the secret information temporarily converted authentication query data.

### [Note 11]

In the authentication system according to note 9, preferably,
in the authentication server apparatus, the matching part converts the secret information temporarily converted authentication query data using the secret information temporary conversion parameter and executes matching with the registration feature data.

### [Note 12]

In the authentication system according to note 5 or 6, preferably, the authentication server apparatus includes:
a challenge generation part that generates a challenge and transmits the challenge to the authentication client apparatus; and
a verification part that receives a response and executes verification the response using the temporary conversion parameter; and
in the authentication client apparatus, the temporary conversion part further converts the challenge using the temporary conversion parameter and transmits the challenge converted to the verification part in the authentication server apparatus as the response.

### [Note 13]

In the authentication system according to note 12, preferably,
in the authentication server apparatus, the verification part executes the verification using part of the predetermined conversion parameter.

### [Note 14]

See the authentication server apparatus according to the above second aspect.

### [Note 15]

See the authentication method according to the above third aspect.

### [Note 16]

See the program according to the above fourth aspect.

The disclosure of the above PTL, etc., is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10: Authentication client apparatus
11: Authentication server apparatus
12: Temporary conversion part
13: Registration feature data storage part
14: Matching part
15: First update information generation part
16: Second update information generation part
17: Composite conversion parameter generation part
101: CPU
102: Memory
103: Input/output interface
104: NIC
105: Internal bus

What is claimed is:

1. An authentication system, comprising:
an authentication client apparatus that comprises
at least a processor; and
a memory in circuit communication with the processor,
wherein the processor is configured to execute program instructions stored in the memory to implement:
a temporary conversion part that receives a feature to be authenticated and converts the feature into authentication query data using a temporary conversion parameter; and
an authentication server apparatus that comprises
at least a processor; and
a memory in circuit communication with the processor,
wherein the processor is configured to execute program instructions stored in the memory to implement:
a registration feature data storage part and a matching part, the registration feature data storage part receiving a feature to be registered in a system and storing registration feature data generated, the matching part executing matching on a basis of the registration feature data and the authentication query data.

2. The authentication system according to claim 1; wherein
in the authentication server apparatus, the matching part converts the registration feature data using the temporary conversion parameter and executes matching.

3. The authentication system according to claim 1; wherein
in the authentication server apparatus, the matching part inversely converts the authentication query data using the temporary conversion parameter and executes matching.

4. The authentication system according to claim 1; wherein in the authentication server apparatus,
at a time of registering the feature to be registered in the system, the registration feature data storage part stores a converted registration feature data that is registered by converting the feature using a predetermined conversion parameter; and
the matching part executes matching between the converted registration feature data and the authentication query data.

5. The authentication system according to claim 4;
wherein the authentication server apparatus further comprises a first update information generation part that generates first update information for updating data converted using the predetermined conversion parameter to data converted using the temporary conversion parameter; and
wherein the matching part updates the converted registration feature data using the first update information and executes matching with the authentication query data.

6. The authentication system according to claim 4;
wherein the authentication server apparatus further comprises a second update information generation part that generates second update information for updating data converted using the temporary conversion parameter to data converted using the predetermined conversion parameter; and
wherein the matching part updates the authentication query data using the second update information and executes matching with the converted registration feature data.

7. The authentication system according to claim 4;
wherein the authentication client apparatus comprises a composite conversion parameter generation part that generates a composite conversion parameter for executing a conversion in which a conversion using the predetermined conversion parameter and a conversion using the temporary conversion parameter are composited;
wherein the temporary conversion part converts the feature to be authenticated into composite converted authentication query data using the composite conversion parameter; and
wherein, in the authentication server apparatus, the matching part reconverts the converted registration feature data using the temporary conversion parameter and executes matching with the composite converted authentication query data.

8. The authentication system according to claim 4;
wherein the authentication client apparatus comprises a composite conversion parameter generation part that generates a composite conversion parameter for executing a conversion in which a conversion using the predetermined conversion parameter and a conversion using the temporary conversion parameter are composited;
wherein the temporary conversion part converts the feature to be authenticated into composite converted authentication query data using the composite conversion parameter; and
wherein, in the authentication server apparatus, the matching part inversely converts the composite converted authentication query data using the temporary conversion parameter and executes matching with the converted registration feature data.

9. The authentication system according to claim 5;
wherein the authentication client apparatus comprises a first secret information temporary conversion parameter generation part that generates a secret information temporary conversion parameter using secret information shared with the authentication server apparatus and the temporary conversion parameter;
wherein the temporary conversion part converts the feature to be authenticated into secret information temporarily converted authentication query data using the secret information temporary conversion parameter, instead of using the temporary conversion parameter; and
wherein the authentication server apparatus comprises a second secret information temporary conversion parameter generation part that generates the secret information temporary conversion parameter using secret information shared with the authentication client apparatus and the temporary conversion parameter.

10. The authentication system according to claim 9; wherein
in the authentication server apparatus, the matching part converts the converted registration feature data using the secret information temporary conversion parameter and executes matching with the secret information temporarily converted authentication query data.

11. The authentication system according to claim 9; wherein
in the authentication server apparatus, the matching part converts the secret information temporarily converted authentication query data using the secret information temporary conversion parameter and executes matching with the registration feature data.

12. The authentication system according to claim 5;
wherein the authentication server apparatus comprises:
a challenge generation part that generates a challenge and transmits the challenge to the authentication client apparatus; and
a verification part that receives a response and executes verification the response using the temporary conversion parameter; and
wherein in the authentication client apparatus, the temporary conversion part further converts the challenge using the temporary conversion parameter and transmits the challenge converted to the verification part in the authentication server apparatus as the response.

13. The authentication system according to claim 12; wherein
in the authentication server apparatus, the verification part executes the verification using part of the predetermined conversion parameter.

14. An authentication method executed by computers loaded on an authentication client apparatus and an authentication server apparatus, comprising:
receiving a feature to be authenticated and converting the feature into authentication query data using a temporary conversion parameter;
receiving a feature to be registered in a system and storing registration feature data generated; and
executing matching on a basis of the registration feature data and the authentication query data.

15. An authentication server apparatus, comprising:
at least a processor; and
a memory in circuit communication with the processor,
wherein the processor is configured to execute program instructions stored in the memory to implement;
a registration feature data storage part that stores registration feature data generated by receiving a feature to be registered in a system; and
a matching part that executes matching on a basis of authentication query data and the registration feature data, the authentication query data being obtained by receiving a feature to be authenticated and converting the feature using a temporary conversion parameter.

16. (canceled)

17. The authentication system according to claim 6;
wherein the authentication client apparatus comprises a first secret information temporary conversion parameter generation part that generates a secret information temporary conversion parameter using secret information shared with the authentication server apparatus and the temporary conversion parameter;
wherein the temporary conversion part converts the feature to be authenticated into secret information temporarily converted authentication query data using the secret information temporary conversion parameter, instead of using the temporary conversion parameter; and
wherein the authentication server apparatus comprises a second secret information temporary conversion parameter generation part that generates the secret information temporary conversion parameter using secret information shared with the authentication client apparatus and the temporary conversion parameter.

18. The authentication system according to claim 7;
wherein the authentication client apparatus comprises a first secret information temporary conversion parameter generation part that generates a secret information temporary conversion parameter using secret information shared with the authentication server apparatus and the temporary conversion parameter;
wherein the temporary conversion part converts the feature to be authenticated into secret information temporarily converted authentication query data using the secret information temporary conversion parameter, instead of using the temporary conversion parameter; and
wherein the authentication server apparatus comprises a second secret information temporary conversion parameter generation part that generates the secret information temporary conversion parameter using secret information shared with the authentication client apparatus and the temporary conversion parameter.

19. The authentication system according to claim 8;
wherein the authentication client apparatus comprises a first secret information temporary conversion parameter generation part that generates a secret information temporary conversion parameter using secret information shared with the authentication server apparatus and the temporary conversion parameter;
wherein the temporary conversion part converts the feature to be authenticated into secret information temporarily converted authentication query data using the secret information temporary conversion parameter, instead of using the temporary conversion parameter; and
wherein the authentication server apparatus comprises a second secret information temporary conversion parameter generation part that generates the secret information temporary conversion parameter using secret information shared with the authentication client apparatus and the temporary conversion parameter.

20. The authentication system according to claim 6;
wherein the authentication server apparatus comprises:
a challenge generation part that generates a challenge and transmits the challenge to the authentication client apparatus; and
a verification part that receives a response and executes verification the response using the temporary conversion parameter; and
wherein in the authentication client apparatus, the temporary conversion part further converts the challenge using the temporary conversion parameter and transmits the challenge converted to the verification part in the authentication server apparatus as the response.
